(19) United States
(12) Patent Application Publication
(10) Pub. No.: US 2008/0087819 A1
(43) Pub. Date: Apr. 17, 2008

(54) METHOD FOR ANALYZING A FLUID SAMPLE

(76) Inventors: Stefan Kalveram, Viernheim (DE); Bernd Roesicke, Mannheim (DE); Frederic Wehowski, Hockenheim (DE); Jean-Michel Asfour, Weinheim (DE)

Correspondence Address: ROCHE DIAGNOSTICS OPERATIONS INC., 9115 Hague Road, Indianapolis, IN, 46250-0457, US

(21) Appl. No.: 11/838,950

(22) Filed: Aug. 15, 2007

(30) Foreign Application Priority Data
Aug. 16, 2006 (EP) 06017021.4

(51) Int. Cl. G01N 23/00

(52) U.S. Cl. 250/307

(57) ABSTRACT

The invention relates to a method for analyzing a fluid sample, such as a body fluid sample in which, after loading a test element with a sample of a fluid, the fluid sample passes into a detection area of the test element and spreads out in the detection area, and in which a filling extent which characterizes the spread of the fluid sample in the detection area is determined using a photometric measurement of the fluid sample in the detection area, wherein the photometric measurement is carried out by means of a first light which is irradiated onto the fluid sample in the detection area, said first light having a first wavelength for which, when at least one chemical parameter of the fluid is varied, the fluid has an essentially constant optical behaviour with respect to at least one spectroscopic parameter selected from a group of spectroscopic measurement parameters consisting of absorption, transmission, remission and fluorescence, and wherein the at least one chemical parameter of the fluid comprises at least one of the following properties: chemical composition, concentration and activity of one or more compounds contained in the fluid.

### REFERENCE TO RELATED APPLICATIONS

The present application is based on and claims priority to European Patent Application No. 06017021.4, filed Aug. 16, 2006, which is hereby incorporated by reference in its entirety.

### BACKGROUND

The invention relates to a method for analyzing a fluid sample, such as a body fluid sample, and a measurement system for conducting such method.

Fluid samples are analyzed for different analysis purposes in various applications, for example in order to determine the concentration or presence of an analyte in the fluid. Examples of body fluids which are analyzed in this way include urine and blood.

According to one known technology in order to determine the concentration or presence of an analyte in the fluid sample, use is made of measurement systems comprising a measurement device that uses test elements in which a measurement area is formed, i.e. an area of the last element in which the fluid sample is introduced so as then to determine the concentration or presence of an analyte. Known examples of such test elements include so-called test strips. In some embodiments, the measurement area of the test element may include a composite consisting of one or more mesh or nonwoven material sections, or the measurement area of the test elements may comprise an open cavity structure.

Test elements often include one or more detection areas for determining that a fluid sample has in fact been introduced to the test element. Detection areas in known structures are typically downstream of the measurement area. For example, in capillary-fill electrochemical type test elements, one or a pair of electrodes may be provided downstream of measurement electrodes and configured to measure a change in current or applied potential when the fluid sample reaches the detection area. This detection often indicates sufficient sample volume is present for conducting an analysis. In photometric type test elements, it is known to provide a detection area downstream of the measurement area, each area having its own light source when the test element is used with a suitable photometric measurement device, the light source for the detection area being configured to irradiate only the sample introduced into the detection area so as to avoid any interference with the irradiation of the sample in the measurement area. To achieve this, it is known to utilize optical imaging means, such as lenses, to direct the light appropriately. The optical imaging means complicates the analysis system set-up and also increases the space requirement of the analysis arrangement.

Other analysis systems detect introduction of fluid sample by measuring the wetting/moistening of a measurement area by the sample fluid, typically by measuring the quantity of reflected light returned from the measurement area.

Examples of test elements and their respective analyzing systems are disclosed in U.S. Pat. Nos. 6,707,554 B1 and 4,420,566 which are hereby incorporated herein by reference. Drawbacks of such systems include more complicated set-up and larger sample volume requirements.

### SUMMARY

It is an object of the invention is to provide an improved method for analyzing a fluid sample, such as a body fluid sample, which can be carried out with reduced complexity, thereby providing a savings in terms of material and costs, while retaining a high sensitivity of the analysis. It is further an object to provide such a method which further determines the degree of filling of a test element, which may be a consideration in the analysis of the sample fluid.

This object is achieved according to one embodiment of the invention by a method for analyzing a fluid sample in which, after introducing the fluid sample to a test element, the fluid sample passes into a detection area of the test elements and spreads out in the detection area, and in which a filling extent which characterizes the spread of the fluid sample in the detection area is determined using a photometric measurement of the fluid sample in the detection area, wherein the photometric measurement is carried out by means of a first light which is irradiated onto the fluid sample in the detection area, said first light having a first wavelength for which the fluid has an essentially constant optical behaviour with respect to at least one spectroscopic parameter when at least one chemical parameter of the fluid is varied, the spectroscopic parameter being selected from the group of spectroscopic parameters consisting of absorption, transmission, remission and fluorescence, wherein the at least one chemical parameter comprises at least one of composition, concentration and activity of one or more compounds in the fluid.

In other embodiments, the method comprises introducing a fluid sample to a test element the test element comprising at least a measurement area and a detection area, the sample sequentially spreading into the measurement area and the detection area, photometrically measuring an extent of filling of the detection area by the fluid sample, such measuring comprising irradiating the sample in the detection area with a first light and measuring at least one spectroscopic parameter selected from the group of parameters consisting of absorption, transmission, remission and fluorescence, the first light having a first wavelength at which the at least one spectroscopic parameter measured therefrom is substantially independent of at least one chemical parameter of the sample, such as chemical composition, concentration of compounds in the sample and activity of such compounds, correlating the measured spectroscopic parameter to the extent of the filling of the detection area, and analyzing the sample in the measurement area.

Wavelengths at which the behaviour of a spectroscopic parameter for a fluid to be analyzed is substantially independent of the variation in at least one chemical parameter of the fluid are assigned to a characteristic point in the wavelength spectrum of the spectroscopic parameter for the fluid, which is also known as the isobestic or isosbestic point. Similarly, the wavelength used for photometrically measuring the extent of filling of the detection area can also be referred to as the isobestic wavelength. The substantial independence of the spectroscopic parameter at this wavelength makes it possible to evaluate the measurement signals detected during the photometric measurement of sample filling as an indication of a “filling extent” or “extent of filling” of the detection area, namely the extent to which the detection area is filled with the fluid sample.

The proposed method makes it possible to omit material- and cost-intensive optical imaging systems in the measurement arrangement for analyzing sample introduced to the test element, since a spatially resolve analysis of the detection area and measurement area is no longer necessary. There need not be a clean spatial separation of the irradiation areas for the measurement light for the photometric analysis of the measurement area on the one hand and the detection light, namely the light for analyzing the detection area, on the other hand. This is difficult to achieve without an optical imaging system. Despite this, due to the targeted choice of the wavelength for the measurement light of the photometric analysis of the detection area, the proposed method ensures a reliable determination of the filling extents of the detection area that is unaffected by certain chemical parameters of the sample.

However, reliable information about the extent of filling of the detection area by the fluid sample is important not just when using a photometric analysis of the detection area. The filling of the detection area typically occurs by the fluid sample spreading essentially over the entire surface of the detection area. Even if the fluid sample is analyzed in the measurement area by other methods, for example other physical methods, an electrochemical method or other chemical methods, the information about the filling extent in the detection area is an important parameter for precisely evaluating the measurement results, particularly if the thickness of the sample area is negligible compared to the surface area. Using the information about the filling extent, it is possible, for example, to gain knowledge about the volume of the fluid sample that has been analyzed. This can be of some importance when the measurement area and the detection area are formed so that they at least partially overlap in the test element. Indeed, for maximizing spatial efficiencies (and thus minimizing sample volume), it may also be provided that the measurement area and the detection area are one and the same. In general, the proposed method provides a possibility for determining the extent of filling of an area with the fluid sample, regardless of the purpose for which this information will then be used.

The proposed method is particularly suitable for analyzing fluid samples in test elements in which rapid reaction chemistry is used. The filling of the detection area and a measurement reaction take place essentially in parallel here, which is why an independent filling extent control which is not influenced by the analyte concentration can be useful.

The chemical composition of a compound contained in the fluid may change in various ways. By way of example, in one embodiment, within the sample fluid introduced to the test element, a starting product may be gradually converted into a reaction product, so that the reaction product is increasingly present in the fluid sample. For example, in connection with the chemical parameter of concentration, the behaviour for the spectroscopic parameter of remission for an aqueous glucose solution changes only insignificantly for different glucose concentrations for light of given wavelengths. With regard to the parameter of activity typically a chemical or biochemical activity is checked. This may be for example an enzymatic activity, particularly in the field of biochemistry, which is an indication of a reaction-accelerating effect of a catalyst or an enzyme. A biological activity can also be checked as the parameter, which is generally understood to mean the effectiveness of a substance in the biological system, for example as an enzyme.

One further development of the invention provides that the detection area is “wetted” by the fluid when the fluid sample spreads out in the detection area. Wetting is generally understood to mean the formation of an interface between the fluid and a solid body material, such as the surfaces of a sample cavity. In one embodiment of the invention, it may be provided that the detection area is “moistened” by the fluid when the fluid sample spreads out therein. A “wetting” on the one hand and a “moistening” on the other hand may in each case occur exclusively or in combination when the detection area is filled with the fluid sample. If the detection area is formed for example as an open cavity such that there is no material that absorbs the fluid, the wetting will lead to the filling of the detection area. However, if an absorbent material is also formed within the detection area, filling of the detection area may lead to the so-called moistening of this material (which is sometimes also regarded as a special case of wetting since inner surfaces of the material are essentially wetted in this case).

In one embodiment of the invention, it may be provided that the photometric measurement of them filling extent is carried out in a time-resolved manner. In other embodiments, a temporal curve of the at least one spectroscopic parameter is measured. In yet other embodiments, the temporal curve is used to determine the filling extent.

In one embodiment of the invention, the filling extent is determined from measured values for the at least one spectroscopic parameter by resolving the temporal curve for known values of the spectroscopic parameter and correlating the indicated value to a filling extent. Typically, values for the spectroscopic parameter are measured at a pre-determined time after the start of the irradiation of the first light at the first wavelength. By selecting a pre-determined time, a measurement point which is particularly suitable (e.g. has a high degree of resolution for different parameter values) for determining the filling extent can be selected on the temporal curve of the analyzed spectroscopic parameter after the irradiation of the first light at the particular isobestic wavelength. Moreover, the predetermined time for a measurement point is optimized with respect to known signal-to-noise ratio information. It is thus possible for example, to select a measurement point for which the signal-to-noise ratio is particularly good.

In one embodiment of the present invention, the pre-determined time is selected to be a time at which the at least one spectroscopic parameter assumes an extreme value. A suitable extreme value is, for example, a minimum of the spectroscopic measurement parameter in the temporal curve after the irradiation of the measurement light. However, in other embodiments a maximum of the curve can also be used.

In various embodiments, the test element can comprise any suitable type of test element, including a test strip, a test field, a test element having a cavity structure for holding the fluid sample, and micro-fluidic test element. Furthermore, the method can be used with test elements having a wide range of structural features, for example test elements based on woven webs, non-woven, paper, film, microstructures or the like. These include in particular test strips which are usually designed as strips comprising a composite of non-woven materials. Other test elements comprise a cavity structures in a base body, which is produced for example as an injection-moulded part. Formed in the cavity structure are various areas which can be used to analyze the fluid sample. Besides the detection area, these include for example a reagent area, in which one or more reagents are arranged in the measurement area which can react in particular with an analyte contained in the fluid, or a reaction area in which the reaction between the one or more reagents with the analyte of the fluid takes place. One or more areas may be formed in a spatially overlapping manner, both in the test strips and in the test elements comprising the cavity structure. For micro-fluidic test elements in a particular embodiment, the required volume of the fluid sample can be further minimized.

In another embodiment of the present invention, an analysis measurement for analyzing the fluid sample is also carried out. For example, the concentration or presence of an analyte in the fluid sample is determined. An analysis measurement is provided in which the fluid sample in the measurement area is analyzed in addition to the photometric measurement of the filling extent in the detection area. However, the detection of other physical or chemical properties of the fluid sample in the test element may be provided as an alternative or in addition to the determination of concentration or presence of the analyte. Various measurement methods can be used for this. For example, the analysis measurement may be an electrochemical measurement and photometric measurement.

In certain embodiments of the present invention, the analysis measurement is based on a function of the value measured for the filling extent, using a data signal which is derived from electronically accessible information about the measured value. The data signal may for example be used to display information about the filling extent of the detection area on a display of a measurement device, for the purpose of informing the user. As an alternative or in addition, the use of the data signal for additional measurement data evaluations is also possible.

In the embodiments of the present invention, the timing of the analysis measurement relative to the photometric measurement of the filling extent can be configured as desired. For example, the analysis measurement may at least partially overlap temporally with the photometric measurement wherein the analysis measurement may begin entirely before or after the photometric measurement, or wherein the analysis measurement may end before or after the photometric measurement. The photometric measurement and the analysis measurement may be carried out in any temporal relationship with one another depending on the specific measurement system and a select measurement methodology. Multiple repetition of the photometric measurement may also be provided, for example before, during and after the analysis measurement. The filling extent of the detection area can thus be monitored continuously.

In one other embodiment of the present invention, the analysis measurement is carried out in a measurement area of the test element which is it a distance from the detection area. In for the filling extent to be determined at the start of the analysis measurement. In that case, the information about the filling extent in the detection area can be used as an indicator for the filling of the measurement area, although clearly the reverse arrangement of the measurement area and the detection area will enable a similar use of the filling extent information as an indicator of filling of the measurement area. In yet other embodiments, the detection area and the measurement area are configured to at least partially spatially overlap or even be one and the same.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows a schematic diagram of a measurement system for analyzing a sample of a fluid;

FIG. 2 shows a graph of a temporal curve of the remission at a wavelength of 490 nm for blood samples with different glucose concentrations;

FIG. 3 shows a graph of a temporal curve of the remission at a wavelength of 650 nm for blood samples with different glucose concentrations;

FIG. 4 shows a graph of calculated values for a temporal curve of the remission for different filling extents of a detection area; and

FIG. 5 shows a graph of the temporal derivation of the calculated values in FIG. 4.

Skilled artisans appreciate that elements in the figures are illustrated for simplicity and clarity and have not necessarily been drawn to scale. For example, the dimensions of some of the elements in the figure may be exaggerated relative to other elements to help improve understanding of the embodiment(s) of the present invention

In order that the present invention may be more rapidly understood, reference is made to the following examples, which are intended to illustrate the present invention, but not limit the scope thereof:

### DETAILED DESCRIPTION OF EMBODIMENTS OF THE PRESENT INVENTION

The following description of the preferred embodiment is merely exemplary in nature and is in no way intended to limit the present invention or its application or uses.

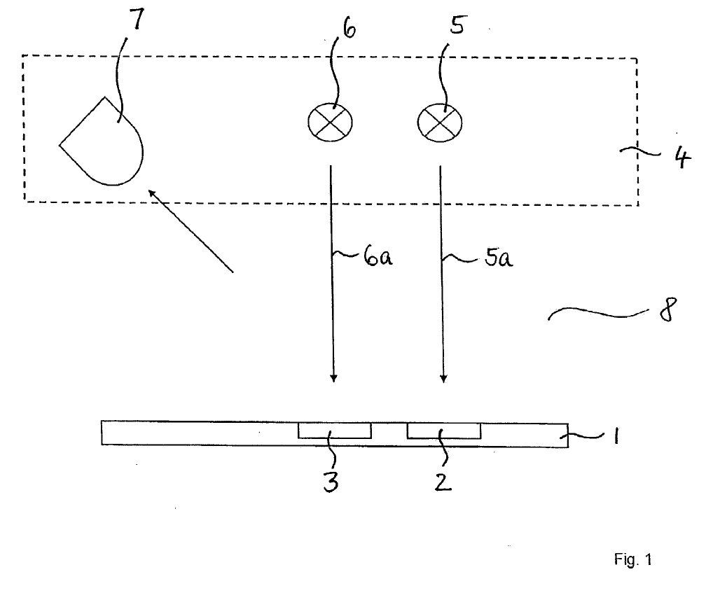

FIG. 1 shows a schematic diagram of a measurement system for analyzing a fluid sample. in a test element. In the test element, a detection area 2 and a measurement area 3 downstream of the detection area 2 are formed in a test field plane 1. Arranged opposite the test field plane 1 is a photometric measurement device 4 which has a first light source 5 and a second light source 6 and also a detector 7 associated with the two light sources 5, 6. The detector 7 typically comprises a photodiode. An area 8 between the test field plane 1 and the photometric measurement device 4 is typically left free of optical imaging systems such as lenses. By means of the first light source 5, which is for example a single-color light-emitting diode, first light 5a at a first wavelength is generated and is irradiated onto the test field plane I in such a way that it covers at least the detection area 2. By means of the second light source 6, which is also designed as a single-color light-emitting diode, second light 6a at a second wavelength is generated and is likewise irradiated onto the test field plane 1 so that it covers at least the measurement area 3. Optionally, the areas over which first light 5a and the second light 6a propagate in the test field plane 1 may be delimited, such as by simple screens (not shown).

In order to carry out an analysis of a fluid sample, the sample is introduced into the test field plane 1 on the test element so that the fluid sample passes firstly into the detection area 2 and then into the measurement area 3. In embodiments in which the detection area 2 and measurement area 3 partially or completely overlap (not shown) the filling of the areas is nearly or essentially simultaneous. The spread of the fluid sample in the test element takes place for example in a manner driven by capillary forces. However, an active distribution of the fluid sample in the test element by means of a micro-pump (not shown) may also be provided. The light response (e.g. remission) which is typically diffusely reflected by the fluid sample in the detection area 2 and the measurement area 3 is then detected by means of the detector 7. In order to separate the response signals for the first light 5a on the one hand and the second light 6a on the other hand, color filters (not shown) which are adapted to the first light wavelength and the second light wavelength may be arranged upstream of the detector 7. For example, narrow-band color filters are suitable for this purpose.

By means of the detector 7, it is possible to detect response light which is reflected by the fluid sample in the detection area 2 and the measurement area 3. In addition or as an alternative, it is of course also possible in a photometric measurement analysis to measure light which is transmitted through with detection area 2 and the measurement area 3. Depending on the specific application, the person skilled in the art can select light components which can be evaluated in a suitable manner for the information to be determined from the analyses.

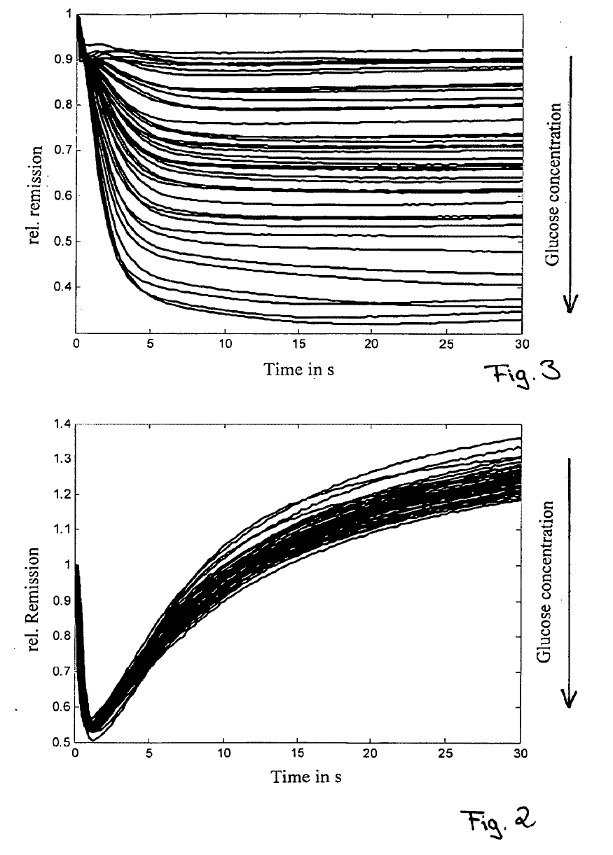

FIG. 2 shows a graph of a temporal curse of the remission for a first wavelength of 490 nm for blood samples with different glucose concentration between 25 mg/dl and 600 mg/dl.

It can the seen that the remission behaviour of the blood samples is essentially independent of the glucose concentration particularly around a minimum 20 of the temporal curve of the remission at 490 nm. The minimum 20 is reached approximately one to two seconds after the start of wetting. As seen in the graph of FIG. 2, a bleaching effect then occurs, which leads to an increase in the remission signal. The curves shown in FIG. 2 are known as isobestic.

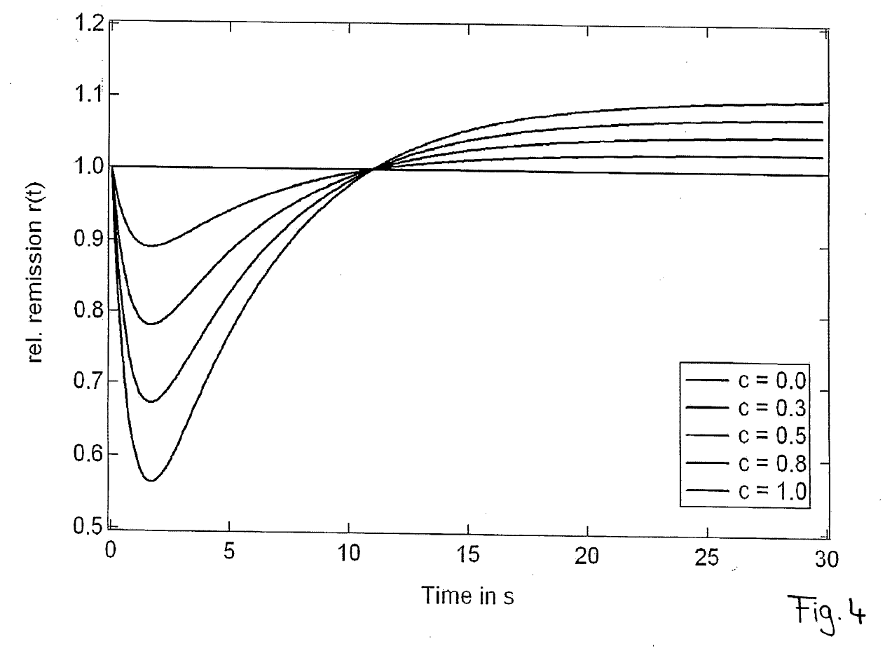

FIG. 3 shows a graph of a temporal curve of the remission for a wavelength of 650 nm for blood samples with different glucose concentrations. In a manner comparable to the analyses shown in FIG. 2, the glucose concentration was varied between 25 mg/dl and 600 mg/dl. It can readily be seen that, at the wavelength of 650 nm, the degree of remission the blood samples with different glucose concentrations differs in each case, even if a similar temporal curve is measured.

Photometric measurements at a first wavelength of approximately 490 nm, as shown in FIG. 2 for blood samples with different glucose concentrations, can be used to determine the extent to which the detection area 2 is filled with the blood sample to be analyzed, be it by wetting and/or moistening. The evaluation used to determine a filling extent for the filling of the detection area 2 by the fluid will be explained in more detail below. In general, the experimentally determined measurement data here are compared with calculated model data in order thus to determine the filling extent.

It can be seen from the experimental analyses threat the curve of absolute remission R(t) can be described approximately by an exponential rise with a subsequent exponential fall. Formulated in a general manner, the following relationship is thus obtained for fill wetting:

$$R ( t ) = a [ 1 - exp ( - \frac{t - {t}_{1}}{{τ}_{1}} ) ] * exp ( - \frac{t - {t}_{2}}{{τ}_{2}} ) + Δ$$

τ₁ and τ₂ are temporal constants which characterise the exponential curves of the rise and fall. a is a constant. Δ is an offset.

Based on a blank value b=1, the experimentally measured curve is described by the following parameters: Δ=9, τ₁=1, τ₂=5, a=0.9, t₂=0 and t₁=τ₁ ln(b−Δ)/a).

If the area of the detection area 2 (cf. FIG. 1) is wetted/moistened only to an extent c, the following is obtained for the measured absolute remission RT(t) of the partial wetting:
RT(t)=c*R(t)+(1−c)*b

Here, C assumes values between 0 and 1 depending on the extent of filling of the detection area 2. The following is then obtained for the relative remission r(t):

$$r ( t ) = \frac{R T ( t )}{b}$$

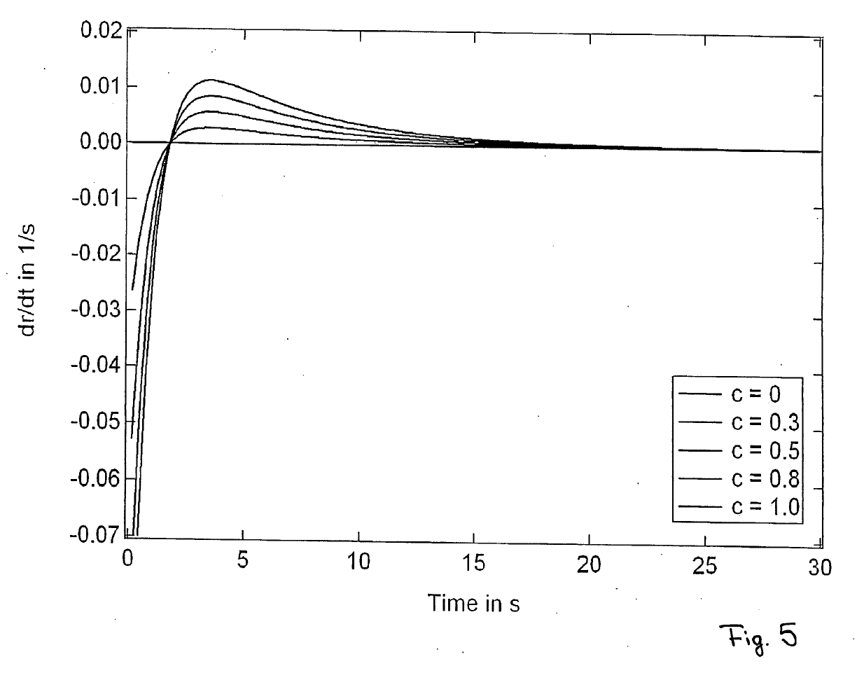

The temporal curves (shown in FIGS. 4 and 5) of the remission for various values of c were calculated On the basis of the model considerations described above.

FIG. 4 shows a graph of calculated values for a temporal curve of the remission for different filling extents of a detection area 2, i.e. degrees of wetting and/or moistening, which are expressed by different values for c. Depending on c, i.e. as a function of the filling extent, the value of the minimum 20 changes for the various remission curves. A comparison of the calculated curves with experimentally determined measurement parameters determined during the photometric measurement of a spectroscopic parameter thus allows the determination of the filling extent for the detection area 2.

FIG. 5 shows a graph of the temporal derivation for the curves in FIG. 4. The zero crossing for all curves takes place at a point which corresponds to the minimum 20 in the graph in FIG. 4.

Besides the value for the minimum 20, other properties of the remission curves can also be used as an indication of the extent of filling of the detection area 2, for example the rise or fall in remission. Information about the rate of filling of the detection area by the fluid sample can optionally also be derived therefrom.

The method for determining the wetting/moistening of the detection area 2 has been explained above on the basis of spectroscopic measurements, specifically with regard to remission in the embodiments disclosed above. Measurement data for the spectroscopic parameters of transmission or absorption can be evaluated in an analogous manner if these are carried out at a suitable (isobestic) wavelength. Suitable wavelengths can be determined from preliminary experiments depending on the specific application or are known to the person skilled in the art for a given chemical composition. The method can be carried out analogously with any dependences of the curves of the spectroscopic parameter at the selected wavelength on other parameters, for example temperature or air humidity.

The described method provides a possibility which can be used with advantage in any measurement system to determine the filling extent of an area to be taken up by a fluid, typically an area to be moistened or wetted.

The detection area and the measurement area may be formed separately or so as to at least partially overlap.

Due to the integral nature of the method according to the invention, it allows reliable detection of wetting without any spatially resolved measurement. The method according to the invention is therefore in principle independent of the shape of the measurement and detection areas, provided that these are illuminated homogeneously.

The features disclosed in the above description, the claims and the drawing may be important both individually and in any combination with one another for implementing the invention in its various embodiments.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modification and variations are possible without departing from the scope of the present invention defined in the appended claims. More specifically, although some aspects of the present invention are identified herein as preferred or particularly advantageous, it is contemplated that the present invention is not necessarily limited to these preferred aspects of the present invention.

What is claimed is:

1. A method for analyzing a fluid sample, comprising:
introducing the fluid sample to a test element, the test element comprising at least at least a measurement area and a detection area, the sample sequentially or essentially simultaneously spreading into the detection area and the measurement area;
photometrically measuring an extent of filling of the detection area by the fluid sample, said measuring comprising:
irradiating the sample in the detection area with a first light and measuring at least one spectroscopic parameter selected from the group of parameters consisting of absorption, transmission, remission and fluorescence, the first light having a first wavelength at which the at least one spectroscopic parameter measured therefrom is substantially independent of at least one chemical parameter of the sample comprising at least one of composition, concentration of compounds in the sample and activity of such compounds; and
correlating the measured spectroscopic parameter to the extent of the filling of the detection area; and
analyzing the sample in the measurement area.

2. The method according to claim 1, wherein the detection area is wetted by the fluid sample when the fluid sample spreads out in the detection area.

3. The method according to claim 1, wherein the detection area is moistened by the fluid sample when the fluid sample spreads out by the detection area.

4. The method according to claim 1, wherein the measuring of the extent of filling is carried out in a time-resolved manner.

5. The method according to claim 4, wherein a temporal curve of the at least one spectroscopic parameter is measured.

6. The method according to claim 5, wherein the temporal curve is correlated to a value of the extent of filling.

7. The method according to any one of claim 4, wherein the extent of filling is determined from measured values for the at least one spectroscopic parameter which are measured at a pre-determined time after the start of the irradiating of the fluid sample with the first light.

8. The method according to claim 7, wherein the pre-determined time is selected to be a time at which at least one spectroscopic parameter comprises an extreme value.

9. The method according to claim 1, characterized in that the test element comprises one of a test strip, a test field, a test element having a cavity structure for holding the fluid sample, and a micro-fluidic test element.

10. The method according to claim 1, wherein the analyzing the sample comprises carrying out an analysis measurement.

11. The method according to claim 10, wherein the analysis measurement comprises one of an electrochemical measurement and a photometric measurement.

12. The method according to claim 10, wherein the analysis measurement is based on a function of a value measured for the extent of filling, said function comprising a data signal which is derived from electronically accessible information about the measured value.

13. The method according to claim 10, wherein the analysis measurement at least partially overlaps temporally with the photometric measurement.

14. The method according to claim 13, wherein the analysis measurement begins before or after the photometric measurement.

15. The method according to claim 13, wherein the analysis measurement ends before or after the photometric measurement.

16. The method according to claim 10, wherein the analysis measurement is carried out in the measurement area of the test element.

17. The method according to claim 1, wherein the measurement area and the detection area at least partially overlap.

18. The method according to claim 17, wherein the measurement area and the detection area are the same.

19. The method for analyzing a fluid sample, comprising:
introducing the sample to a test element, wherein the fluid sample passes into a detection area of the test element and spreads out in the detection area; and
determining a filling extent, said filling extent characterizing the spread of the fluid sample in the detection area, said determining comprising a photometric measurement of the fluid sample in the detection area, wherein the photometric measurement comprises irradiating a first light onto the fluid sample in the detection area, said first light having a first wavelength for which the fluid has an essentially constant optical behaviour with respect to at least one spectroscopic parameter when at least one chemical parameter of the fluid is varied, said spectroscopic parameter being selected from a group of spectroscopic parameters consisting of absorption, transmission, remission and fluorescence, wherein the at least one chemical parameter of the fluid characterizes at least one of composition, concentration and activity of one or more compounds contained in the fluid.
